(19) United States
(12) Patent Application Publication
(10) Pub. No.: US 2025/0121422 A1
(43) Pub. Date: Apr. 17, 2025

(54) SYSTEMS AND METHODS FOR JOGGLING CURVED PARTS WITHOUT PART-SPECIFIC DIES

(71) Applicant: FAIRMOUNT TECHNOLOGIES, LLC, Wichita, KS (US)

(72) Inventor: Viswanathan MADHAVAN, Wichita, KS (US)

(73) Assignee: FAIRMOUNT TECHNOLOGIES, LLC, Wichita, KS (US)

(21) Appl. No.: 18/917,276

(22) Filed: Oct. 16, 2024

Related U.S. Application Data
(60) Provisional application No. 63/590,609, filed on Oct. 16, 2023.

(51) Int. Cl. B21D 11/18; B21D 5/00

(52) U.S. Cl. CPC B21D 11/18; B21D 5/006; B21D 5/008

(57) ABSTRACT

According to at least one embodiment a method for joggling elongate parts curved may include clamping a first vise across a first cross-section of a workpiece immediately outside a first end of a joggle segment of the workpiece and clamping a second vise across a second cross-section immediately outside the second end of the joggle segment. The method may further include actuating relative motion of the vises with respect to each other in a joggling direction to achieve a controlled distance of motion corresponding to a predetermined joggle depth and unloading the vises to obtain a joggled part.

### BACKGROUND

In semi-monocoque airframe construction, about 50% of structural components are built from long extrusions or roll formed sections, many of which are curved to a required contour of the wing or fuselage. Longitudinal members are called stiffeners, longerons, etc., while transverse members are called frames, chords, etc. Joggles are offsets created in extruded components to allow lengthwise members to cross transverse members, to create the overlap required at the ends of components so they can be spliced together with lap joints, etc. A typical joggle has a joggle transition length (also sometimes called joggle length), L, and a joggle depth (or offset), D.

Compared to other types of joggling, ‘section joggling’ that involves shear displacement of the section across the joggle transition length is widely applicable for all types of cross-sections. Legs of the cross-section along the shear displacement direction undergo in-plane shear deformation (henceforth called ‘shear legs’) while those that are transverse to this direction undergo bending along bend lines along their width (henceforth referred to as ‘bending legs’). Recalling concepts such as principal strains, Mohr's circle for strain, etc., a pure shear strain is understood to be characterized by tensile strain and compressive strain in the plane of the shear leg at angles ±45° to the shear displacement (joggle offset) direction. If all regions of the part outside of the joggle transition (which is demarcated by the joggle start and end planes, which may or may not be identifiable on joggled parts) were not held rigidly and portions of the shear leg are allowed to have additional deformation by sliding with respect to the tooling, partial rotation of the shear leg over the joggle transition length, in the direction of the moment causing the shear displacement, causes extra compressive and tensile strains that add to the compression and tension due to shear. This increases the tendency of the compression region to buckle and the danger of the leg rolling out of the plane and/or cracking in the tension region. However, spreading of the deformation to regions adjacent the joggle transition helps smooth the deformation.

Joggling is currently carried out using presses, press brakes, etc., with special joggling dies that are unchanged from when they were developed last century. Joggling dies typically take the form of dies that act on both sides of parts needing to be joggled, and are offset by the press the distance required for a joggle. Previous joggling includes, for example, section joggling (also referred to as “shear joggling”) using a horizontal plate-like die set in which the part nestles along its length, with spacers matching the cross-section of the part (inside and outside of the cross-section) used to clamp the workpiece (in both transverse directions) to both sides of the “die platform”. An actuator is used to offset one side of the tooling (“movable second die platform”), along with the part clamped in it, in a horizontal direction transverse to the extrusion. Only joggles on straight parts are taught. However, slightly curved parts can also be joggled, but would require part-specific custom tooling for both the inside and the outside of the cross-section (to fill all the gaps between the clamp faces). Joggling can be done only along one horizontal direction. Further, this method allows no support for the shear leg against buckling, The only mention of buckling (or of compression, tension, stretch, wrinkle, or kinking) is a design recommendation that the joggle should be designed such that both legs (“side member sections”) of an angle are joggled outwardly to minimize the tendency for buckling. previous methods further have no provision for measurement of the joggle depth on the workpiece, needing to wait till the workpiece is removed from the dies. They also lack any provision to measure or compensate for springback. Even for creating a second joggle, e.g., to create a so-called double joggle wherein the extrusion is offset in both transverse directions over the same joggle transition length (which is also referred to here as a “vector joggle”), additional spacers need to be used.

Often, the part on the side of the joggle not being pushed down by the press is not clamped down, or clamped with pneumatic cylinders, etc., causing the joggling action of the press to cause localized buckles or kinks in the cross-section when one side is offset with respect to the other for the joggle to be created. These kinks lead to rejection from cracking, parts failing the “fingernail test”, etc. Other quality issues are caused by variation in material properties that cause different amounts of springback, the setup of the joggle dies and shims being incorrect, etc.

When 7000 series components in the −T temper (precipitation hardened condition) need to be joggled, per typical OEM specifications they need to be warmed up to a warm forming temperature of approximately 300° F. to extend their formability and reduce the chance of cracking. This process is called hot joggling, and is more challenging because the dies need to be heated and maintained at a set temperature, and the joggling process should be carried out within narrow windows of temperature and time. Each part should be clamped to the joggling dies for a certain time to reach the joggling temperature, whereupon the joggling “hit” is initiated. If the die temperature or hold time is too low, the part temperature may not reach the allowed range and this may cause cracking. If the die temperature or hold time is too high, the material may get softened by overaging. Some joggling presses use temperature sensors to measure the temperature, typically that of the dies so they can be maintained at a higher temperature, and it is not clear how that temperature and clamping time relates to the actual temperature of the material being joggled, which could be dependent on other variables such as cross-section of the part, shop temperature and thermal cycling of the heaters. The actual amount of part deflection (joggle depth) and other parameters such as the length of the joggle depend on the following: (i) relative thermal expansion of the dies and shims which are typically made of steel and the parts which are aluminum alloys, and (ii) springback, which depends on the mechanical properties of the material as a function of temperature.

When joggling is done on presses dedicated for joggling, the part is clamped to the dies by pneumatic cylinders, to hold the parts in place during joggling. Since pneumatic cylinders do not have very high holding capacity, the dies and cylinders used are large and bulky and still there is change in the length of the part as a portion of the part is pulled into the joggling zone.

Joggling of curved parts is even more problematic since the dies that hold the parts over the large contact length should not change the part curvature during joggling. Hence, curved parts need part-specific joggle dies to form the joggles. Still, if the parts have residual stresses within them from heat treatment, forming, etc., these residual stresses can be re-equilibrated by the thermal cycling, leading to geometry changes. There is nothing that can be done other than to re-joggle them with different shims and to use hand forming to bring the parts back to the required contour.

Furthermore, current joggling of curved parts carried out using hot or cold joggling uses part specific dies that are compensated for springback, is a “black art”, with very few qualified vendors. One approach is to integrate joggling dies into stretch form dies used to curve the part, by machining joggle features into the stretch form dies. After the part is stretch formed to the curve required, segments needing to be joggled are pushed into the joggle features on the stretch form die using a matching punch on a hydraulic cylinder which attaches to the die. Typically, it takes several weeks to months, depending on the complexity of the part, to produce the tooling and then produce the parts. The tooling is often painstakingly “spotted in”, with skilled artisans increasing the location and depth of the joggle features till the joggle and the formed parts meet geometric tolerances.

### SUMMARY

According to at least one embodiment a method for joggling elongate curved parts may include clamping the workpiece in a first vise such that an end plane of jaw clamping of the vise jaws coincides with a first cross-section of the workpiece defining a first end of the joggle transition, positioning and orienting a second clamping vise such that its end plane of jaw clamping coincides with a second cross-section of the workpiece defining the second end of the joggle transition, and clamping the second vise. The method may further include actuating relative motion of the vises with respect to each other in a joggling direction, with or without additional superimposed motions in other degrees of freedom, to achieve a controlled distance of joggling motion that is calculated based on the required joggle depth. The method may further include unclamping one vise and using sensors to measure the springback in the part, re-clamping the vise and changing the distance of joggling motion to compensate for the measured springback. Additional features of the method may include defined contact patches between the jaws and the part, adding flatness maintainers to the jaws to minimize unwanted deformation of the part, heating the jaws to heat the part, measuring the temperature of the region of the part subject to maximum tensile deformation through the vise jaws, and feeding the part through the vises to create joggles at required locations along the part. An exemplary apparatus embodying the method to joggle components is also provided.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1A shows an exemplary joggle according to a wipe joggling method.

FIG. 1B shows an exemplary joggle according to a section joggling method.

FIG. 1C shows a “double joggle”, according to an embodiment

FIG. 1D shows a schematic drawing of a “perfect” section joggle according to an embodiment.

FIG. 1E shows a “normal” section joggle, wherein there is some deformation of the shear legs on either side of the joggle transition length, which is correlated with rotation of the section in the joggle transition length.

FIG. 2A shows an exemplary arrangement of two jaws, one each on the fixed and moving vises, positioned and oriented to determine the joggle transition length on the part.

FIG. 2B shows five of six jaws cooperating to clamp the workpiece, which are slidably held within pockets in the moving and fixed vises, and clamped by clamps operating within the pockets according to an exemplary embodiment.

FIG. 2C shows a set of three jaws, held slideably within a pocket on the moving vise, cooperating to clamp an angled workpiece according to an exemplary embodiment.

FIG. 2D shows a close-up view, from a different orientation, of the part being held by the jaws according to an exemplary embodiment.

FIG. 2E shows a close-up view of a jaw with integral contact patches that would contact parts being clamped, and an integral flatness maintainer that sticks out of the end face of the jaw according to an embodiment.

FIG. 3 shows a set of jaws with provisions for embedding heaters and temperature sensors in them.

FIG. 4A shows the overall arrangement of the sensors and their target surfaces according to an exemplary embodiment.

FIG. 4B shows the overall arrangement of the actuators that position the moving vise in 6 DOF with respect to the fixed vise according to an exemplary embodiment.

FIG. 5 shows the use of four double acting actuators to control the distance of the moving vise from the fixed vise according to an exemplary embodiment.

FIG. 6 shows a workpiece feeding mechanism according to an exemplary embodiment.

FIG. 7. Shows an overall view of an exemplary automated joggling machine with a safety enclosure according to an exemplary embodiment.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

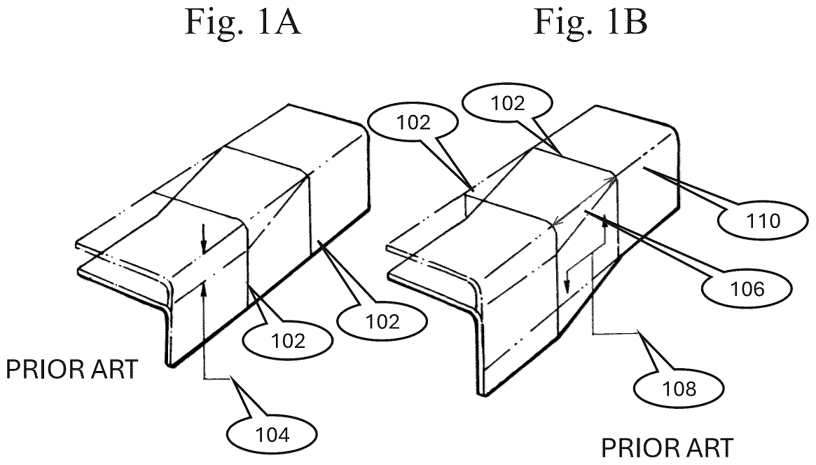

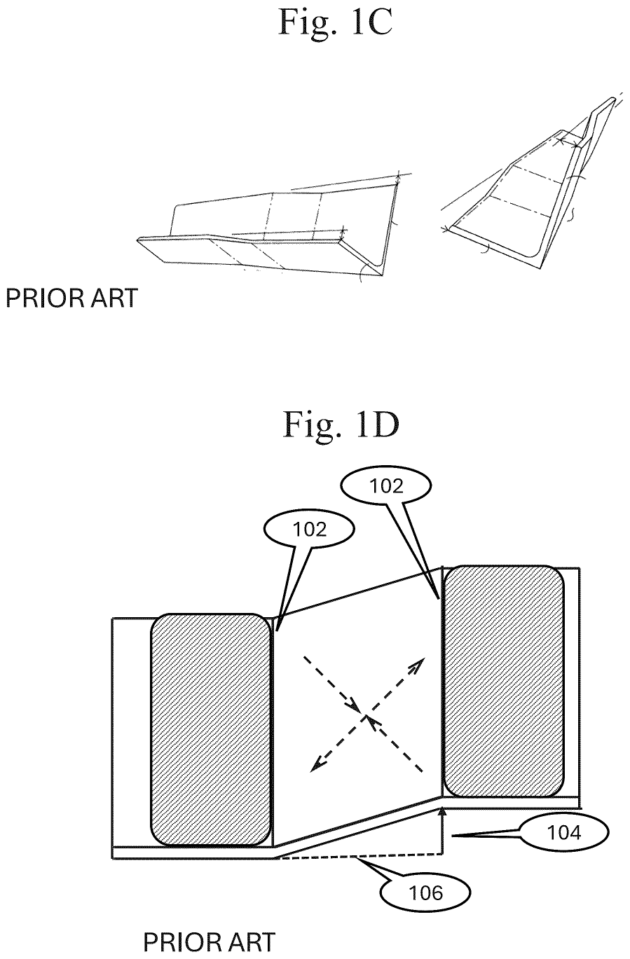

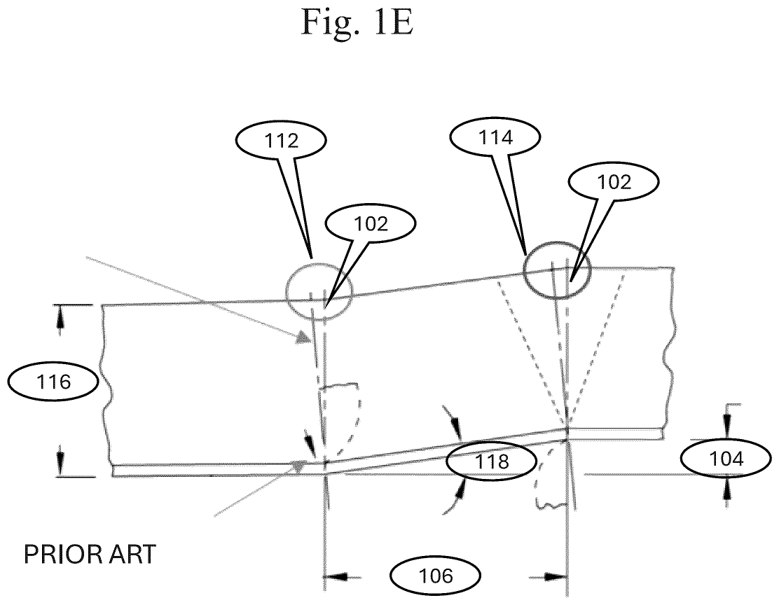

Referring to FIGS. 1A-1D, various prior art joggles may be shown and described.

FIG. 1A shows an exemplary joggle according to a wipe joggle method and FIG. 1B shows an exemplary joggle according to a section joggling method. A joggling section or a joggle transition may be defined by two end planes of joggle clamping 102. Furthermore, a mold line 110 that is the virtual intersection of the two outside faces of the L-section, a joggle depth 104, and a joggle transition length 106 may be defined. The shear movement 108 may further be shown. FIG. 1C shows an exemplary double joggle according to an embodiment, where the section is offset in both transverse directions.

FIG. 1D shows a schematic of a perfect section joggle, also referred to here as “shear joggle” according to an embodiment. It may be understood the “shear joggle” may be formed by holding the entire cross-section, including the shear legs, perfectly rigid outside of the joggle transition length over which one side of the workpiece is offset from the other. Perfect shear deformation may only be approximated, with a very short joggle transition length 104, and with high clamping forces, and may still lead to tensile strain and compressive strain at +45° to the shear direction as shown. It may be understood the sharp changes in geometry may also be undesirable in many cases.

FIG. 1E shows a “normal” section joggle according to an exemplary embodiment. It may be understood that the normal section joggle may have some deformation of the shear legs outside of either side of the joggle transition length (also called as “joggle length”), which is correlated with rotation of the section by the joggle angle 118 in the joggle transition length. This rotation may also be thought of as an extension of the bending occurring at the bending leg into the shear leg, characterized by compressive strain at the concave bend (looking from the shear leg) increasing with distance from the bent leg in region 112, and increasing tensile strain at the convex bend in region 114. It may be understood that both the tension and compression add to the corresponding tension and compression arising from the shear deformation and may increase the risk of buckling and tearing.

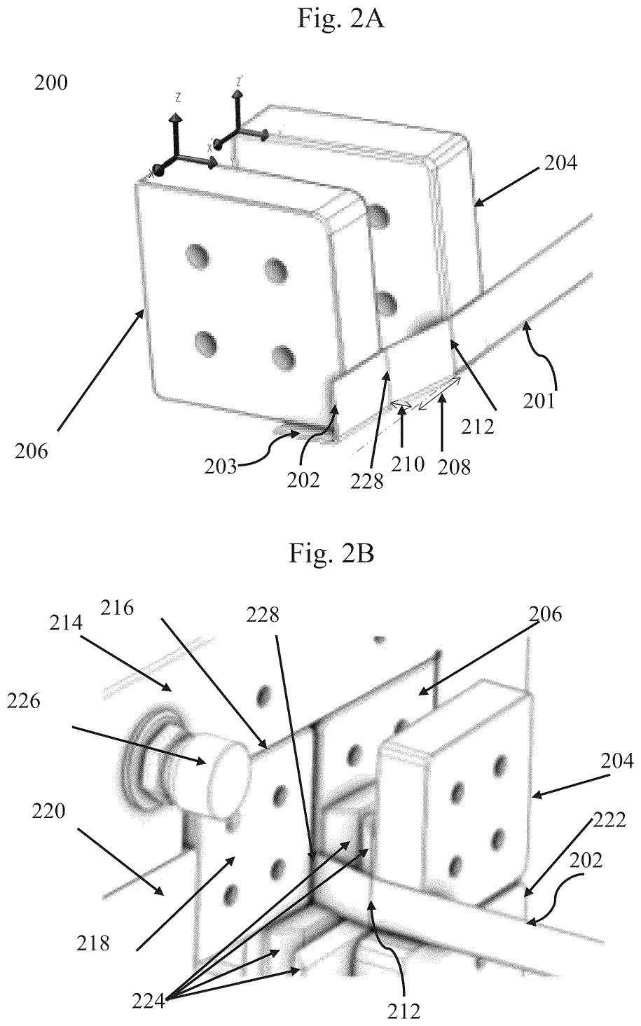

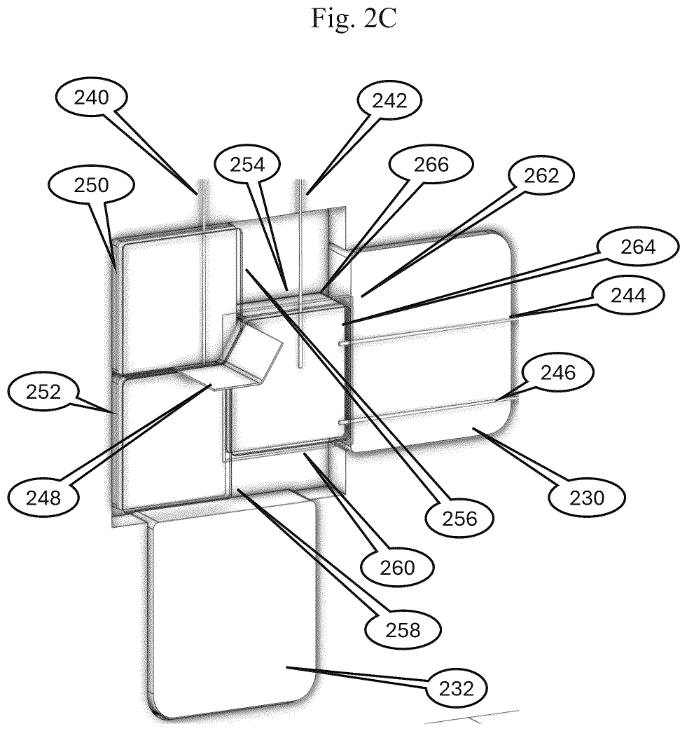

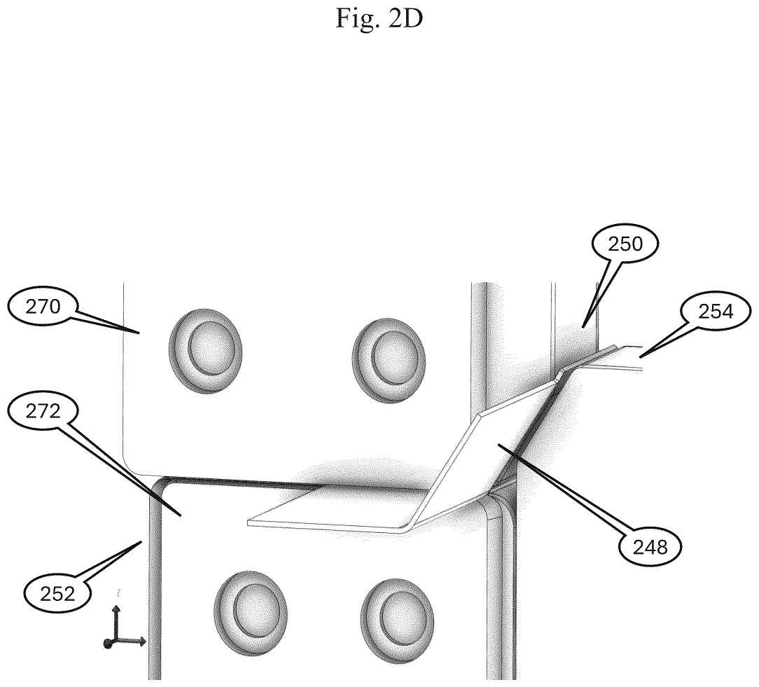

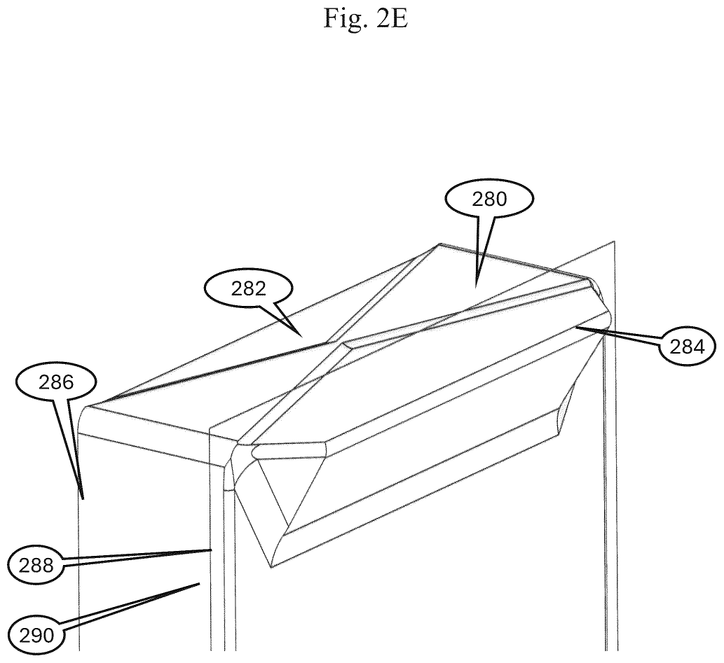

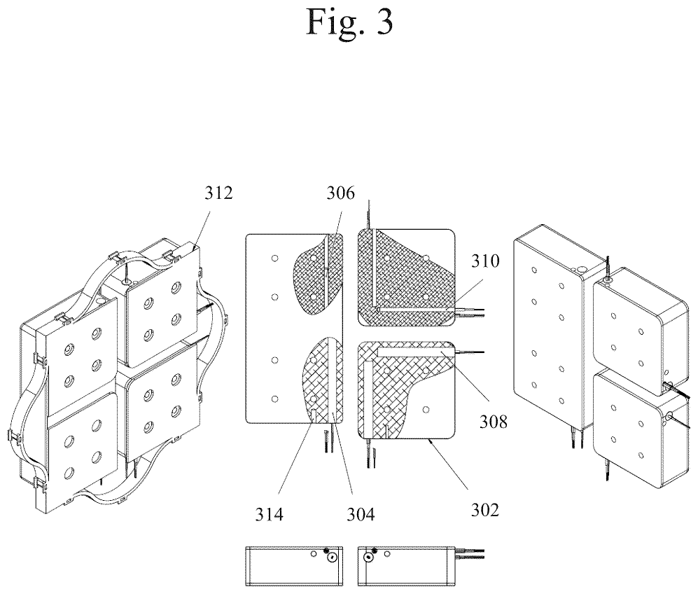

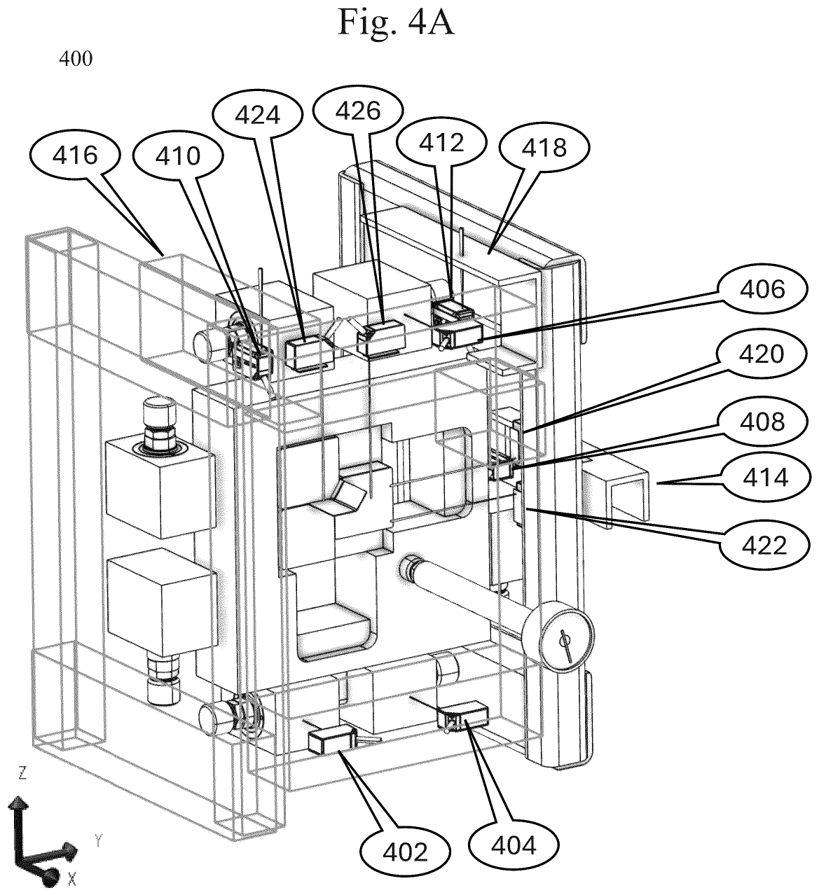

Referring to FIG. 2A-2B, an exemplary configuration of jaws may be shown and described. FIG. 2A shows an arrangement of two jaws, one each on the fixed and moving vises, positioned and oriented to determine the joggle transition length on a curved workpiece according to an embodiment. FIG. 2B shows five of six jaws cooperating to clamp the workpiece, which are slidably held within pockets in the moving and fixed vises, and clamped in two directions by horizontal and vertical clamps operating within each of the pockets according to an embodiment. The configuration shown may include a workpiece 201 with a bending leg 202 and a shear leg 203, a first jaw 204 that is part of a moving vise, a second jaw 206 that is part of the fixed vise whose front face is pointed to by 214. Two triads indicating the coordinate orientations of the fixed vise (unprimed coordinates) and moving vises (primed coordinates) are also shown, but the origin may lie along a different point in the Y-Z or Y′-Z′ planes, e.g. along the intersection of the mold line with these planes. The end plane of joggle clamping of the moving vise (the Y′Z′ plane) may be the plane transverse to the part that contains the tangent edge of the fillet radius of the side face of the jaw 204, along which the bending leg 202 of the workpiece 201 bends, pointed to by 212. The longitudinal distance between the two vises (which may be understood to be directly related to the joggle transition length 208), and the yaw angle (rotation about a vertical (Z) axis) that is necessary for the clamping faces of the jaws of the moving vise to be oriented such that its end plane of joggle clamping (EPJC-MV) is the transverse plane of the workpiece, and lies along the required bend line 212 may be set by four handwheel or motor driven screws 226 (of which only one is shown) with swivel feet that bear against the front face of the moving vise. It may be understood that the feet may keep the end plane of jaw clamping of the moving vise at a known distance and orientation with respect to the fixed vise, but allow the moving vise to be translated in any direction parallel to this plane by sliding along low friction circular surfaces at the end faces of the swivel feet. Since these feet can only push the vises apart, other means, such as hydraulic cylinders or springs or toggle clamps may be required to force the vises together. Though three screws 226 may be sufficient to control three degrees of freedom (DOFs) of rigid body motion of the moving vise, namely the joggle length, the yaw angle (C axis, the rotation about the Z axis), and the pitch angle (B axis, the rotation about the Y or Y′ axis), four screws may be used due to other design considerations. However, according to an exemplary embodiment, only three of the screws 226 may be positioned independently in position control mode, and the fourth screw 226 may be operated in torque controlled mode so it bears against the moving vise without causing any of the other feet to come off. In some embodiments if double acting cylinders with swivel joints on each end are used to control these three degrees of freedom, in both tension and compression, they may obviate the need for any other means (e.g. the toggle clamps to force the vises together) to control these same degrees of freedom. Position controlled hydraulic cylinders also allow the joggle length and the yaw and pitch angles to be controlled as a function of time during joggling, to achieve universal bending along both axes with superimposed stretch. When the joggling actuators are discussed it may be seen that they can also control the roll axis (A axis, rotation about X axis). Controlling all three orientations of the moving vise, in addition to displacing it in the Y′ and Z′ directions allows not only the average bend curvatures (or radii) to be controlled but also the end plane orientation to also be controlled as required. This enables control of the rate of change of curvature along the free length being bent.

In an embodiment a portion of the workpiece 201 may be held between two jaws 206 and 218 of the fixed vise 214, that may be slidably held within pocket 216 (e.g., by using shoulder screws from the back, tightening into the threaded holes on the end faces of the jaws through slots in the pocket). In the configuration shown, jaw 218 may be clamped against jaw 206, with the bending leg 202 of the workpiece held in between, by clamp 220 constrained to move in the horizontal direction. This may create the bending line 228 along which the end plane of jaw clamping of the fixed vise (EPJC-FV) is located. Similarly, jaws 204 and 222 may be held slidably in a pocket of the moving vise and jaw 222 may be clamped against 204 with the shear leg 203 of the workpiece in between, by a vertical clamp (constrained to move in the vertical direction) on the moving vise. Actuation of the moving vise in the horizontal direction may create the joggle shown, with bending of the bending leg 202 along bend lines coinciding with the EPJC-MV and EPJC-FV, and shear deformation of the shear leg 203. Buckling of the shear leg 203, especially likely near vise jaw 204, may be countered by the use of flatness maintainers 224.

While the clamps move in one direction to clamp the jaws against a fixed side of a pocket in the embodiment shown, for some uses bi-directional, self-centering clamping like in machine vises, may be advantageous and may be employed by minor modifications to the vise geometry. Additionally, magnets may be placed on the faces of the jaws that are acted upon by the clamp faces, or springs connecting the two, may be used to withdraw the jaws along with the clamps during unclamping. These, and other such minor modifications may be incorporated into the various embodiments.

The moving vise may be actuated by hydraulic actuators, for example eight single-acting hydraulic actuators arranged to mimic four double acting cylinders, that may push against the frame to slide the front face of the moving vise in the Y′-Z′ plane over the four swivel feet. Three independent position controllers may control two orthogonal translations in this plane (along Y′ and Z′ directions in FIG. 2A) and the roll degree of freedom (rotation about X′, the axis perpendicular to the front face of the moving vise). This may allow flexibility in controlling the direction of joggle displacement to be along any vector in the Y′Z′ plane, as well as the magnitude of the displacement, i.e., joggle depth.

FIG. 2C shows a set of three jaws, held slidably within a pocket on the moving vise, cooperating to clamp an angled workpiece 248 according to an exemplary embodiment. The set of three jaws include a first moving vise jaw 250, a second moving vise jaw 252, a third moving vise jaw 254, a first fixed vise jaw 256, a second fixed vise jaw 258, and a third fixed vise jaw 260. The configuration may further contain an end plane of jaw clamping for the fixed vise (EPJC-FV) at 262. Only the front section of the jaws of the fixed vise through EPJC-FV are shown, in wireframe mode, for clarity. The moving vise jaw face 264 may further be shown. The horizontal clamp 230 and the vertical clamp 232 that snug the workpiece in place prior to clamping it may also be shown. In addition, four laser beams of non-contact displacement transducers (e.g. those that work by the principle of triangulation based on the image of the laser spot on a linear sensor array) attached to the moving vise may be shown, with two (240 and 242) being oriented to measure the position and displacement of the horizontal leg of the part (the web) along the Z′ direction, and the other two (244 and 246) measuring the position of the other leg of the part (the flange) along the Y′ direction. The lines along which each of the beams measures may be adjustable, while keeping the orientation constant, to suit the particular measurement needs.

The two pairs of sensors may allow measurement of both the position and orientation of two legs of the cross-section with respect to the moving vise, which may be used for springback measurement. According to an exemplary embodiment, after the programmed joggling depth is reached, the moving vise may be unclamped with the part still being clamped in the fixed vise. The deflection of the part upon unclamping may be understood to be the springback, and may be measured by the springback sensors. Since the measurement plane is offset from the end plane of jaw clamping of the moving vise 266, the measured displacement of the part in the measurement plane may need to be scaled up by a factor to estimate the springback occurring at EPJC-MV, which may then be added to the joggle displacement to compensate for the springback. The scale factor may be calculated based on measured increments in position of the moving vise and corresponding increments in the reading of the springback sensor, assuming a linear model for the workpiece deflection in the gap between the two vises.

FIG. 2D shows a close-up view, from a different orientation, of the workpiece 248 being held by the jaws according to an exemplary embodiment. Two add-on flatness maintainers (FM) 270 and 272 may be attached to the end faces of the jaws, which may cooperate to maintain flatness of the shear leg (horizontal web) of the cross-section of the workpiece 248. The flatness maintainers 270 and 272 may be attached to the end faces of vise jaws while holding both the bottom surface of the vise jaw and the flatness maintainer flat against a horizontal surface plate. Shims may be used between the bottom surface of flatness maintainers 270 and 272 and the surface plate while attaching the flatness maintainers 270 and 272, to set a precise gap, for example, one that matches the relief cuts used to create the raised contact patches. It may be understood that in some embodiments it is not essential that the jaws have the contact patches. It may be understood that the FMs may prevent measurement of the shear leg of the part. In some embodiments the displacement of the shear leg may not be important, but in some embodiments the displacement may be determined. Holes or slots in the FM may be used to allow access for the laser sensors to measure the shear leg of the workpiece also, such features may be wide enough on the top face (opposite the bottom face) of the FM to not interfere with the space required for the triangulation sensor to view the reflected beam.

FIG. 2E shows a close-up view of a jaw with an upraised contact patch 280 on its top face according to an exemplary embodiment. When a part is clamped to this top face, contact may occur only over the contact patch 280. The contact patch may be created by shallow relief 282, which may be for example cuts a few thousandths of an inch deep made with a ball-nose end mill. Clamping force and friction over the contact patch may be adjusted to be effective in preventing rotation of the workpiece section over the clamped area. The relief cuts may allow the joggle deformation to spread beyond the joggle transition into the area of the shear leg located over these relief cuts. This may reduce the peak magnitude of both the tensile and compressive strains in the shear leg, and may promote robust joggling with reduced risk of failure by buckling or tearing. In contrast, side face 286 which is clamped against the bending leg may not have any relief cuts or contact patches, without which contact may occur over the entire side face. The entire side face 286 may be treated to increase its friction and improve the ability of short length jaws to hold the part rigidly during the joggling operation without rotation with respect to the jaws. Label 288 identifies the tangent line between the side face and the fillet radius between the side and front faces as the bend line at which the bending leg is bent by the joggling action. The end plane of jaw clamping, 290, is the plane transverse to the part that coincides with this bending line.

FIG. 2E also shows an integral flatness maintainer 284 that sticks out of the end face (front face) of the jaw according to an exemplary embodiment. The integral flatness maintainer 284 may also extend into the joggle transition and may prevent any tendency of the shear leg to deflect out of flatness. The FM may be advantageous in production applications where large numbers of joggles are made on the same class of parts, where they would maintain a precise gap over time.

FIG. 3 shows a set of jaws for hot joggling 300 according to an exemplary embodiment. The set of jaws for hot joggling may include a hot joggling jaw 302, a full-length heater 304, a temperature sensor 306, a half length heater 308, a temperature sensor in a quarter segment die 310, a jaw holder that can manipulate and connect the components of the jaws for hot joggling 312, holes for attaching thin strips of insulators 314 such as Garolite so that heat is retained in the jaws while keeping the vises cool. The embedded heaters and temperature sensors may enable controlled temperature cycling of the parts for performing hot joggling. The holes for the temperature sensors may extend through the jaws to touch one or more surfaces of the legs of the parts being clamped by the jaws. Additional temperature sensors touching the legs of the part through holes in the flatness maintainers may also be provided. The jaws may also include a jaw holder that integrates the individual elements into a hot joggling die pack with provisions for allowing the joggling motion of the jaws, routing the cables robustly, etc., while also permitting the whole assembly to be safely and easily handled when loading and unloading from the vise. A provision for attaching thermal insulators to faces of the jaws that touch the vise may also be provided.

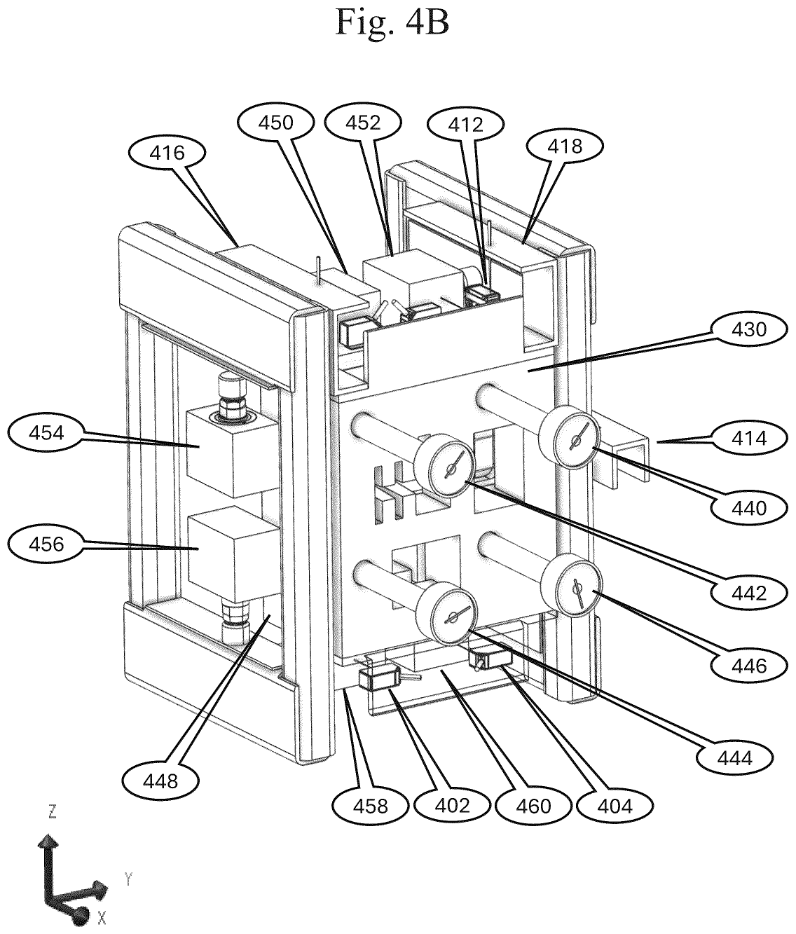

FIG. 4A shows the overall arrangement of distance or displacement sensors and their target surfaces according to an exemplary embodiment. Three sensors (402, 404, and 406) may be fixed to the fixed vise and may have their measuring directions oriented along the X axis to measure the X position of the end plane of the vise jaws of the moving vise along X, as well as its two rotations, namely, pitch about Y axis and yaw about Z axis. The sensors 402, 404, and 406 may measure planar surfaces fixed to the moving vise and at known offsets to the end plane of jaw clamping of the vise jaws of the moving vise (EPJC-MV). Three additional sensors 408, 410, and 412 may be fixed to the moving vise and may measure the joggle depth in the Y and Z directions as well as roll around the X axis. Targets 414, 416, and 418 for the sensors 408, 410, and 412, respectively, may be fixed to the fixed vise at locations where displacements due to joggling action are expected to be negligible. Using the above six sensors, three positions and three orientations of the moving vise with respect to the fixed vise may be measured.

Two other sensors 420 and 422 may be fixed to the moving vise measure the position of the part along the Y′ direction (along the face of the moving vise) to measure change in position and orientation of the vertical leg (flange) of the part due to springback when the moving vise is unclamped, and two sensors (424, 426) may similarly measure the position and springback of the horizontal leg (web) of the part along Z′. All four sensors may measure along planes at known offsets to the end plane of jaw clamping of the moving vise. For clarity of the interior structure, several parts such as the fixed vise and the vertical frame in the foreground are shown just by wireframe representations of their bounding boxes.

FIG. 4B shows the overall arrangement of the actuators that position the moving vise 448 in all six degrees of freedom (6 DOF) of rigid body motion with respect to fixed vise 430, along with some of the sensors and measurement targets that are visible according to an exemplary embodiment. The rear face of the fixed vise 430 (which is in the foreground with the moving vise 448 in the background) may have four large screws that go through the fixed vise 430 and end in the swivel feet shown in FIG. 2B. Rotating these screws may move the swivel feet in and out of the fixed vise 430. High force toggle clamps may engage with a springy sheet metal hook and may be used to keep the moving vise clamped against the feet of the four screws so that turning the screws may cause the moving vise to both move away and towards the fixed vise. Handwheels, for example Handwheel 440, Handwheel 442, Handwheel 444, and Handwheel 446 may be used to turn the screws and may have gravity dial indicators counting the number of turns and indicating the partial revolutions. Though three screws may be sufficient to adjust the distance between the vises and two orientations of the moving vise with respect to fixed vise, a fourth screw may be used for stability. The fourth screw may be controlled in torque mode so as to just engage the swivel foot of that screw to bear against the moving vise, without causing any of the other three swivel feet to come out of contact with the moving vise. The screws may be rotated manually or automatically using motors with a spline connection to the screw. The indicators on the handwheels may be used to provide approximate guidance to the operator on how much each of the screws needs to be turned. Other visual feedback may be provided on the human machine interface through a graphical user interface to the controller, which may enable the moving vise to be precisely positioned at a known distance and orientation. Equations enabling calculation of the sensor readings 402, 404, and 406 that will indicate that the moving vise is at the required position and orientation may be derived from a kinematic model of the machine. Similarly, screw positions required to achieve required sensor readings may also be calculated using other equations. Calibration of the machine kinematics may involve determining a few constants in these equations based on sensor readings 402, 404, and 406 for known positions and orientations of the moving vise. The known positions and orientations may be set using calibration artifacts or by measuring the relative position and orientation of the moving vise with respect to the fixed vise using, for example, a portable coordinate measuring machine (PCMM).

Each of the four side faces of the moving vise 448 (of which the top and left are partially visible) may have a pair of single acting actuators pointing in opposing directions rigidly attached to it. For example, the top side may have a left top side actuator 450 and a right top side actuator 452. Likewise the left side may have a top left side actuator 454 and a bottom left side actuator 456. The bottom side may have a left bottom side actuator 458 and right bottom side actuator 460. Likewise, may be true for each of the other sides. It may be understood that two pairs of single acting cylinders may be used, rather than a single double acting cylinder, for tight position control of the moving vise when the pitch or yaw angles is non-zero. The advance port of these cylinders may be connected to the A and B ports of an electro-proportional flow control valve. Causing the advance of one cylinder, for example, the actuator 454 at the top on the left side face of the moving vise 448, may cause an equal amount of oil to flow out of the bottom cylinder 456 on the same left side face to tank through the other port of the flow control valve. It may be understood that in an embodiment the swivel feet attached to the cylinder rods bear against rigid regions of the machine frame, therefore the resultant effect of extending the rod of the top actuator may be a downward motion of the left side of the moving vise. The vertical position of the left side (Z1 axis) may be controlled using the measurement of sensor 410 as the actuator position in a feedback control loop of the controller. In a similar manner the vertical position of the right side of the moving vise (Z2 axis) may be controlled independently using sensor reading 412 for feedback control. The required values of these two control variables Z1 and Z2 may be calculated from the overall Z position and A rotation (roll about the X axis) at which the moving vise is required to be set. Actuation in the Y direction may be accomplished by using a single flow control valve to control both pairs of single acting actuators at the top and bottom faces of the moving vise, with position feedback from 408, the Y sensor. Low friction circular contact surfaces on the feet and highly polished wear surfaces attached to the frame that the actuators push against, that permit sliding of the swivel feet with minimum friction and wear, may also be provided.

The total distance between the centers of the spheres of the swivel feet may be at a minimum when the moving vise is parallel to the fixed vise. When the moving vise tilts with respect to the fixed vise it may also tilt with respect to the machine frame, which may cause the total distance between the centers of the swivel feet to increase for the feet to stay in contact with the frame members and to continue to push against them. The hydraulic flow control valves may automatically achieve this by filling more fluid into the cylinders that need to extend than the fluid drained from the opposing cylinder when the vise is titled, and draining more fluid from the cylinders that need to contract than adding fluid to the opposing cylinder. Thus the pair of single acting cylinders may act as a double-ended double acting cylinder of variable body length allowing the cylinder body to be rigidly fixed to the moving vise. It may be understood that in some embodiments the described functionality achieved by using the pair of single acting cylinders as described if not replicable by a double ended double acting cylinder.

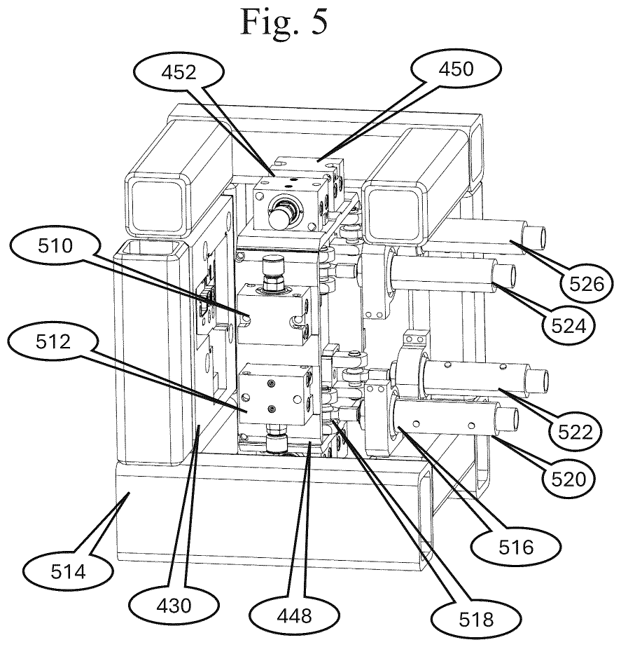

FIG. 5 shows the use of four double acting actuators 520, 522, 524, and 526 to control the distance of a moving vise 448 from a fixed vise 430, as well as its pitch and yaw orientations relative to the fixed vise according to an exemplary embodiment. The body of each of the cylinders, for example the top right cylinder 526 and the top left cylinder 524 or the bottom left cylinder 520 and the bottom right cylinder 522, may be fixed at a point on a machine frame 514, as is shown for cylinder 520 through a spherical bearing 516, and its actuator (piston) may be connected to the moving vise through a swivel rod end 518. The four cylinders may be controlled using, for example, three or four flow control valves to control the three DOFs of the moving vise 448. They may be controlled both prior to clamping of the workpiece by the jaws of the moving vise, as well as during the joggling and springback moves to enable 6 DOF movement of the moving vise with respect to the fixed vise. This enables complex non-planar joggles, e.g., a curved joggle along a leg of a part that is curved in the cross-section. In such cases, the flatness maintainer may change to have curved surfaces preventing buckling of the curved surfaces, and it may be more appropriate to call them buckling suppressors. FIG. 5 also shows a more rigid machine frame according to a different exemplary embodiment. However, some frame members in the foreground are hidden to show the interior structure of the moving vise hydraulic actuation embodiment shown as an example.

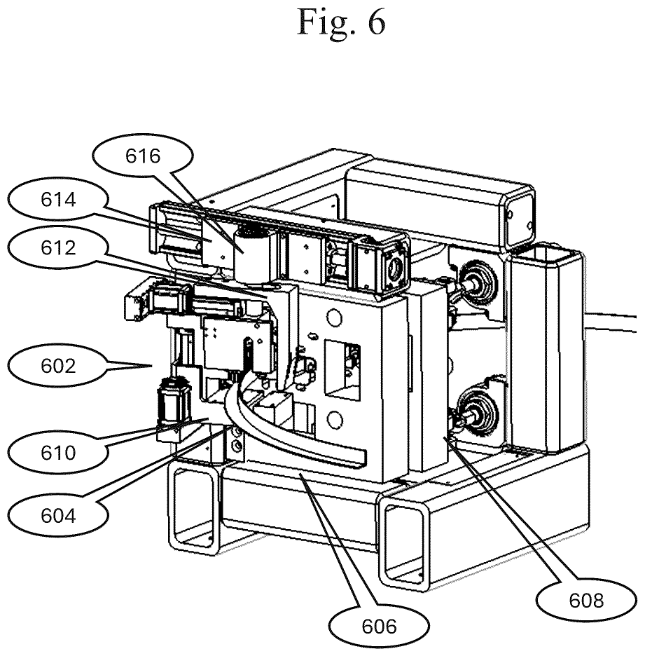

FIG. 6 shows a workpiece feeder integrated with an automatic joggling machine such as those described above, according to an exemplary embodiment. The workpiece feeder 602 may feed a workpiece 604 longitudinally through both a fixed vise 606 and moving vises 608, and position them at the correct locations for joggling or forming. The feeder may have motor driven friction wheels to move the part, and encoder wheels to allow feedback control of the position of the part precisely. The workpiece feeder 602 may clamp the horizontal leg (web) of the part in between opposed pairs of Z-clamps 610 which may be, for example, made of wheels. The Z-clamps 610 may hold the workpiece 604 at the correct height along the Z-axis, with a small clearance with the bottom face of the fixed jaws in quadrant 1. Y-clamps 612, which may also include wheels, may force the vertical leg (flange) of the workpiece 604 against the friction wheels. This may allow the friction wheels to move the workpiece 604. The workpiece 604 location may be accurately measured through encoder wheels whose rotation tracks the longitudinal movement of the workpiece 604. The body of the workpiece feeder 602 may pivot about an axis parallel to the line of contact between the friction wheels and the flange of the workpiece 604 and may be oriented about a vertical (C) pivot axis 616 by an actuator 614 at an angle that holds the Y-clamping plane transverse to the longitudinal direction of the workpiece 604 at the clamping location. The actuator 614 may be mounted on the carriage of the actuator (slide) that also positions the backlash free pivot of the feeder unit comprised of two opposed angular contact bearings. The actuator 614 may position the pivot at the correct location required for pivot axis 616 to intersect the curve of the longitudinal direction of the workpiece 604. This location may be determined by positioning the workpiece 604 correctly for clamping in the fixed vise (i.e., locating the part such that the plane defining the beginning of the joggle transition is located coplanar to the end plane of jaw clamping of the fixed vise 606 (EPJC-FV), with the fillet between the vertical (flange) and horizontal (web) legs of the part tangent to the corresponding fillet in the jaws), and finding the intersection between the flange of the workpiece 604 and the plane offset from the YZ plane of the fixed vise 606 along which the pivot of the feeder is moved by this actuator. The above calculations are done using the geometric definition of the workpiece 604 and the kinematics of the mechanism. The end result may be a CNC program that synchronizes the longitudinal feed movement of the workpiece 604 by the workpiece feeder 602 (X-axis of feeder) with the Y and C axis movements required for the workpiece feeder 602 to locate the workpiece 604 correctly with respect to the vise jaws.

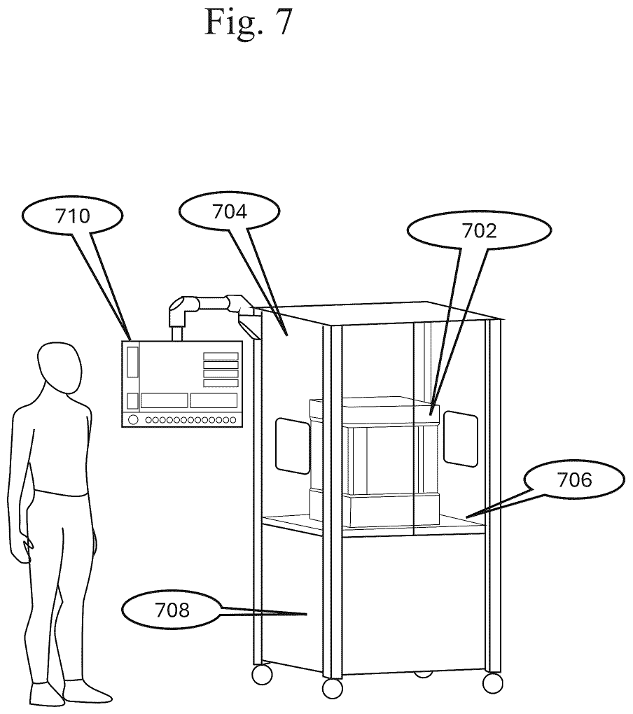

FIG. 7. Shows an overall view of an automated joggling machine with a safety enclosure according to an exemplary embodiment. An automated joggling machine 702 may be contained within an enclosure 704 which may protect a user during operation of the machine 702. the machine 702 may be fixed to a base 706 via the machine's 702 frame, with space beneath for controls and hydraulics 708. The automated joggling machine may further include a human machine interface with a graphical user interface 710 through which the operator may use the machine.

In one or more exemplary embodiment systems and methods for joggling curved parts without part specific dies may be provided.

In an embodiment a system for joggling curved parts may include two vises having flat jaws that clamp on either side of workpiece to be joggled, such that the end faces of each set of jaws coincide with (or lie along) one of the two cross-sections of the part between which the joggle is to be created. It may further include mechanical, hydraulic, etc. actuators to move the vises with respect to one another to create the joggle in the length of the part between the vises through shear and/or bending deformation. In some embodiments the clamping of the part by the jaws may be accommodated by mostly elastic deformation in and around the clamped region, with negligible plastic deformation, so that clamping will not alter the longitudinal curvature of the part and it will go back to the previous longitudinal curvature when it is unclamped. In an embodiment this may be achieved by keeping the longitudinal extent of the flat jaws small with respect to the curvature of the part in the region being clamped. The longitudinal distance between the vises may be altered to alter the joggle length (the length of the joggle segment which undergoes shear and/or bending deformation) and the angle between the vises may be altered to match the change in angle of the curved part over the length of the joggle segment. It may be understood that the actuators for positioning or orienting one vise with respect to the other, and for maintaining or changing position during the joggling motion, may be arranged to act directly between the two vises, or through a machine structure interspersed between the two vises. In contrast, it may be advantageous in some embodiments to have the sensors required for measuring the relative movement be directly mounted to one vise to measure the position and orientation of the other vise, so that deflections of the frame do not influence the accuracy of relative positioning of the two vises. This can be achieved, for example, as shown in FIG. 3 by having the fixed vise be shown just by its bounding box so that the internal structure of the machine is clearer. In some embodiments three sensors may be attached to the fixed vise so that their measuring direction is perpendicular to the end face of the jaws of this vise, to measure features of the end face of the jaws of the moving vise. The three sensor readings may uniquely determine the position and orientation of the end face of the vise jaws of the moving vise with respect to that of the fixed vise. The three other degrees of freedom of rigid body motion of the moving vise, namely, two orthogonal translations in the plane of the end face of the moving vise and a rotational degree of freedom about the direction perpendicular to this plane, may be measured by sensors rigidly fixed to the moving vise, which may measure the distance to measuring surfaces attached to the fixed vise. It may be understood that each of the vises may be stiff enough that their deflections are negligible.

In an embodiment one or more flatness enforcers may be used to prevent buckling of the flange or leg of the workpiece that lies along a plane containing the joggling direction.

In an embodiment the workpiece may be clamped through high friction surfaces, for example an anodized aluminum surface, or surfaces containing bonded/electroplated/sprayed abrasive grit, so that the clamping load required by each vise to hold the clamped regions of the part in position, without longitudinal slip, may be minimized, which may help further minimize the longitudinal extent of the clamps and the deformation in the clamped region.

In an embodiment the vises may be held stiffly apart from one another, e.g., by the positioning actuators, while permitting relative motion only along the joggling direction to joggle the workpiece, which may allow for the workpiece to be stretched along the longitudinal direction. It may be understood that the longitudinal tension may reduce the transverse shear and bending stresses required for joggling and may further reduce springback.

In an embodiment the joggle depth may be controlled through the use of high force actuators utilizing a closed loop motion control system, which may move the vises with respect to each other in the joggling direction transverse to the part such that the joggle depth may be adjusted to compensate for springback. Further, springback may be measured at the end of the joggling motion by unclamping one vise at one end of the joggle segment and measuring along the joggle direction how much the part springs back upon being unclamped.

It may be understood that in some embodiments the joggling direction is specified in the plane containing the cross-section at one end of the joggle segment, which may coincide with the end faces of the vise jaws on one of the vises. In those embodiments it may be advantageous to have two actuators moving the vise in two orthogonal directions along the plane containing the end faces of the jaws, so that the joggle direction can lie in any orientation along that plane. Such a joggling operation may be termed as vector joggling, i.e., joggling along a direction specified as a vectorial combination of two orthogonal components. Springback measurement may be carried out using non-contact sensors set to measure the movement of the part in the same two orthogonal directions along the end face of the vise jaws.

In an embodiment distance may be measured using one or more non-contact sensors, such as, for example, a triangulation based laser displacement measuring systems. which may provide calibrated reference surfaces from which relative motion of the workpiece may be measured. It may be understood that by placing the sensors and reference sensors so that the experienced load is negligible, spurious displacement measurements may be avoided.

In an embodiment a computer numerically controlled (CNC) joggling machine may implement one or more of the above described methods. In some embodiments the CNC machine may further use motion control of a moving vise with respect to a stationary vise to form a range of joggles on both curved and straight parts according to one or more of the descriptions above. The CNC machine may further carry out hot joggling using one or more heated dies, heaters, and/or temperature controls.

It may be understood that the above processes may utilize flat jaws made of elastic materials that do not match the curvature of a part being joggled, by clamping over a short length such that elastic recoverable deformation of the part and the jaws is caused without causing significant plastic or permanent deformation of the part.

When the springback is of the order of the excess gap between the vise jaws in the unclamped state (total gap minus the thickness of the clamped leg of the part), springback may be limited by the available gap. To explore this, the vise may be moved in the direction opposite the joggling direction, i.e., the joggle displacement may be reversed gradually. Incremental displacements over timesteps may be measured and the sum of the incremental displacements of the moving vise and the distance to the workpiece measured by the springback sensor may be calculated.

According to an exemplary embodiment for a particular sensor configuration, when a joggle in the +Y direction is reversed by displacing the moving vise in the −Y direction, the distance from 408, the Y sensor, to its target 414 (TY1) increases, but the distances measured by springback sensors 420 (S1Y) and 422 (S2Y) (with their locations adjusted so that both their laser beams impinge on the angled leg (bending leg) of the workpiece and they are able to measure the distance to it) would decrease if the workpiece were free in the unclamped gap and not moving with the vise. For parallel displacement of the moving vise along the Y′ direction, the sum of the distances measured may be constant. The case may be similar for 410 and 412 (the Z1 and Z2) sensors working together with springback sensors 424 (S2Z) and 426 (S2Z) for measuring springback along the Z axis.

For other sensor configurations where this is not the case, either of the sensor readings in each sum may be negated (negation being the additive inverse) so that their sum would be zero when the moving vise is displaced without the workpiece touching the jaws of the vise. It may be understood that if the springback of the workpiece were restricted by the unclamped jaws of the vise, the sum of the two incremental displacements in each step would be non-zero (e.g., positive for the example case of the Y and SY1 sensors discussed above). When the sum of the incremental displacements becomes zero, it may indicate that the unclamped end is not touching either jaw and is free in the vise gap. The reversal distance at which this happens may then be added to the excess gap, to obtain the total springback of the workpiece. The excess gap may be directly measured by continuing the reverse movement until the sum of the increments again starts changing, which may occur when the part begins touching the jaw on the other side of the gap. In this state, the springback sensor reading may stabilize while the distance between 408 the Y sensor and 414, TY1, may continue to increase and the sum begins increasing again. It may be understood that this strategy may be implemented even for parts with small amounts of springback, so that the springback can be verified using this second approach, and the scale factor for the value measured by the springback sensor may be verified and updated as required.

The springback sensors sensitively measuring the deflection of the workpiece with respect to a vise (the moving vise in this instance), may be put to other uses in various exemplary embodiments. For instance, a highly accurate calibration artifact may be clamped in the fixed vise, and the moving vise can be adjusted so that clamping and unclamping it causes no change in the springback sensor readings. If clamping it lightly causes a change in the readings of the springback sensors, the deflection measured may be used to correct the alignment of the vises and reset the actuator offsets. When the clamping action is one-sided, checking the alignment may be accomplished by holding the moving vise deliberately offset in both transverse displacement direction (Y′ and Z′) so as to center the part in within the excess gap and translating the moving vise in both transverse directions till the stationary jaws touch the part, which may be detected by the sum of the springback sensor reading and the corresponding position measurement sensor reading beginning to change as described above for springback measurement. The procedure may be extended to detect which of the two springback sensors measuring along any one direction senses a larger displacement, which may be related to the twist in the calibration artifact and may be used to correctly zero any offset in the roll DOF. The yaw and pitch DOFs may also be zeroed by an extension of the procedure by which the yaw and pitch orientations are adjusted finally by finding orientations that maximize the travel distance before the part meets the jaw face, which may happen when the side clamping faces of the jaws are accurately parallel to the longitudinal surfaces of the calibration artifact.

The above exemplary 5 DOF calibration procedure may be repeated at different longitudinal distances between the moving and fixed vises. Changes in the actuator offsets at which the vises can be considered to be aligned may be related to the difference in orientations of the clamping faces of the jaws of the fixed vise and the corresponding surfaces of the joggle depth targets that serve as reference surfaces for measuring the transverse positions of the moving vise (axis values Y, Z1 and Z2) with respect to the fixed vise. Measured changes may be used to store calibration coefficients that may be used in compensation tables for the Y, Z and A (roll) axes as a function of distance along the X axis.

The springback sensors may also be put to other uses in other exemplary embodiments. For example, with the moving jaw position and orientation calibrated to that of the fixed jaw as above, measurement of the position and orientation of the workpiece legs when the part is clamped in the fixed jaw at a known position along its length may be used to estimate the deviation of the lengthwise profile of the workpiece (its contour) from an expected contour. The greater the longitudinal distance between the vises, the smaller the curvature deviation that may be measured for a given repeatability of the position sensors. Such use may be facilitated by additionally using accurately produced jaws with smooth faces, at clamping loads that would not cause the part to distort, by using part feeders/supports at locations outside of both the fixed and moving vises so the workpiece may be supported against deflection by gravity, and may ensure that the part is held with its length perpendicular to the fixed vise and with the legs aligned with the clamping faces of the vise jaws, for instance, without any roll that may cause the legs to be at a non-zero angle to the jaw faces, so the part may be clamped without any distortion. Satisfaction of these requirements may be verified prior to clamping of the fixed jaw.

A complementary application for inspecting or measuring the contour of the part described above according to an exemplary embodiment, may be to correct or adjust the part to meet the contour requirements within a very tight tolerance. This may be carried out by following a procedure very similar to that used for correcting for springback. A “joggle” displacement that is a nonlinear function of the measured deviation, and a scale factor that depends on the cross-section properties of the part and the longitudinal distance between the vises may be calculated and applied to the part. For parts of significant curvature, the rotation of the moving vise may also follow the transverse displacement to keep the EPJC of the moving vise perpendicular to the longitudinal direction of the part in the deflected position. At the end of this “joggling” step the moving vise may be unclamped, and any residual deviation measured may be used to adjust the scale factor and repeat the displacement. The above capability may also be used in other applications, for example where a part needs to be straightened by using the joggling movement of the vise to reduce any measured deviations from straightness to zero.

The correction process above may be simplified by superimposing a longitudinal stretch to the part in addition to the transverse deflection. When the longitudinal stretching strain for each incremental deformation step is selected to exceed the elastic strain at which yielding begins, and to result in a small permanent stretch of the part, the change in curvature may become a linear function of the transverse displacement, which may simplify the process. It may be understood that for parts of appreciable curvature, the maximum free length whose curvature can adjusted uniformly decreases, even with the rotation of the moving vise following the transverse displacement so that the EPIC of the moving vise remains perpendicular to the longitudinal direction of the part in the deflected position. Superimposing a stretching strain may also decrease the residual stresses, and improves the part quality.

The part correction procedure above may also be used to form initially straight workpieces to required contours as a function of the length. Utilizing the high force reaction capability of the actuators and the structure, and the high accuracy 6 DOF position control capability of the sensors and actuators, several types of deformation may be applied to the workpiece to form the part, including, for example, one or more of simple bending where the part is deflected in a transverse direction, pure bending where the end plane of part clamping (EPJC) of the moving vise is positioned and rotated to maintain a uniform curvature of the workpiece segment between the vises, stretch bending where a longitudinal stretch is superimposed upon the bending strain (to avoid buckling), compression bending, twist bending, forming a single bend or kink by causing the cross-section plane of the part to rotate about the bend line coinciding with the EPJC of the fixed vise by superimposition of longitudinal tension as well as transverse displacement and yaw and or pitch rotation of the moving vise, etc.

The incremental infeed amount by which the part is indexed through the vises may be kept constant or may be varied. This infeed may be achieved by, for example, feeding the part using external feeders that move the part when both sets of vises are unclamped, or by an inch-worm technique where in the moving vise unclamps, changes its distance to the fixed vise, and clamps on the part, after which the fixed vise may repeat this sequence of motions, thereby indexing the part by the distance the part is moved through the fixed vise when it is unclamped. Feeding at a constant increment may alternatively be accomplished using two simple clamp-on fixture elements of length equal to the desired increment, clamping them on onto the part such that they are adjacent one another and adjacent to the rear face of the fixed vise, initiating and completing the desired bending or joggling operation, unclamping the first clamp-on fixture element that is in between the fixed vise and second clamp-on fixture element, removing it, clamping it behind the second fixture element, feeding the part till the second fixture element touches the rear face of the fixed vise, and repeating the steps above. An exemplary low cost configuration may pair the above feature with manual controls to enable the positioning, clamping, forming and measurement of the profile of the part. This may enable a low cost version of to be used as a hand forming aid that can enable a skilled operator to accurately adjust parts in complex manners not currently possible, enabling the hand forming of parts currently not amenable to hand forming.

Additionally, during the forming step, it may be advantageous to clamp the vises with the minimum clamping force required to accurately enforce the desired relative movement of the clamped ends, so that a form imparted in a previous step, to a segment of the workpiece being clamped in the current step, is not changed significantly by the subsequent clamping action. It may be additionally advantageous to line the faces of the jaw inserts with a thin layer of relatively compliant material such as nylon that can accommodate mismatch by elastic compression while the small thickness may limit the longitudinal flexibility. For bending very soft materials, it might be advantageous to set the feed increment to be the sum of the longitudinal width of the vise jaws and the free length of the part being bent (i.e., the distance between EPJCs of the fixed and moving vises). This ensures that the free length formed to contour is not subsequently altered by the clamping action, with the penalty that the relatively short lengths clamped by the vises will remain unbent.

In an exemplary embodiment the forming and/or infeed capabilities may be paired with an inspection capability to measure features of the part using the springback sensors. Inspection of longitudinal geometry of a part, such as the local radius between supports at which the part is held, as well as some transverse features along the cross-section (such as the angle between two legs of the part), at fixed locations along the part, may be carried out using springback sensor measurements of the part surfaces, and further these measurements may be used in conjunction with the known positions and orientations of at least two end supports holding the part to calculate the desired geometric parameters of the part. The above may be carried out using the inch-worming technique described above to feed the part, using only one vise, e.g., the fixed vise, to clamp and hold the part during the measurement step, and using the workpiece measurement sensors mounted to the other vise (e.g., the moving vise) to estimate the average curvature of the free length of the part from the clamped end to the measurement location. It may be understood that for a given resolution of the measurement sensors, the uncertainty in curvature may decrease as the distance between the end supports increases.

Having external feeders feeding the part into one vise and feeding it out of the other vise may enable measurements of improved accuracy, which may help ensure that even very long parts can satisfy overall tolerances on the longitudinal profile of the part. External feeders may also make it possible to inspect the part continuously along the length as it moves through the vise jaws. However, external feeders may need to be positioned and oriented correctly with respect to the vises in order for the part to not be forced into a different profile by contact with the vise jaws. This may be accomplished when the structure positioning and orienting the feeder is connected to the vise adjacent to it, as shown in FIG. 6. The feeder shown may be capable of handling all parts curved in the horizontal plane by using a linear slide to position the feeder in the horizontal direction transverse to the part (Y or Y′ direction) and another linear slide mounted to the first one to orient the feeder, the position and orientation values may be calculated to have the part be centered within each vise's gap (i.e. opening between the unclamped jaws), or to be a small distance away from the vise jaw on either side of the gap. The latter may be advantageous in certain embodiments, for instance, for visual inspection. Additionally, using feeders having a single pair of roller contacts in each of the two transverse directions to clamp and position the part, in at least the supporting location downstream of the feeding movement of the part through the vises, may enable accurate location and orientation of the part even in the presence of abrupt changes in geometry such as joggles. It may also be advantageous in some embodiments to have the feeder and the support structure mounting it to the vise be stiff enough that deflection of the location where the part is held, due to forces exerted on the workpiece by the vises, is negligible. High accuracy fine adjustment of the part curvature may be achieved by holding the part in the feeders and using the moving vise (and/or the Y′ motion of the feeder) to push the workpiece against the vise jaw a desired magnitude in a prescribed direction, without clamping the part, to achieve the desired change in measured distance to the springback sensors, which may be indicative of the part conforming closer to the required contour.

In some embodiments the structure holding the feeder described above in the desired position and orientation in the horizontal plane may be replaced with a robot so that the feeder becomes an end effector of the robot, this arrangement may be used to produce complex bends to make the parts conform to arbitrarily defined space curves with constraints on the geometry imposed by the minimum curvature of the part that can pass through the vises and the feeders, etc.

In an embodiment one or more additional 6 DOF mechanisms described here may be attached in series to the vises and used to control the position of the feeder with respect to the vise adjacent to it. This may have very high force capacity as well as accuracy and may be capable of forming and fine-adjusting the contours of workpieces with very large cross-sections accurately.

When the above is paired with the flexibility of the vises to clamp on complex cross-sections by using jaw inserts having the geometry necessary to mate over certain clamping areas of the cross-section, very complex extrusions may be bent into any required contour. Jaws that are narrowed to clamp the workpiece over very narrow widths along longitudinal direction of the workpiece, may be used to induce compression or bending of features in the cross-section plane, thereby causing the thickness or angle between the legs to change as a function of length along the part.

Considering the features described in the embodiments above, for example but not limited to the configuration of a 6 DOF machine with frame structure enabling very heavy loads to be transmitted in all directions between two nearly parallel blocks whose relative locations can be accurately controlled, with the further capability to measure the deflections of a part or a tool held between the two blocks that then act upon it, it may be understood that the features may be combined using slightly different configurations of the embodiments and put to use for different applications, that may or may not involve causing different accurate effects on the workpiece or tool held in between. For example, scaling up the vises and actuators, use as a high precision tube bending or straightening machine for large tubes may be contemplated. In other embodiments the described machine may additionally be used as an end effector on a large machine capable of 3 DOF positioning, which may enable the large machine to keep a tool perpendicular to the local surface normal of a part in applications that require large forces and precise control of the location and orientation of the tool. Mounting an indenter or a roller ball that is commonly used in single point incremental forming to the fixed vise, a 6 DOF incremental forming machine capable of applying forming forces as high as hundreds of tons while keeping the indenter perpendicular to the local surface normal may be developed. Such a machine may be understood to be much stiffer and capable of much more force in the lateral directions of the indenter (comparable to the transverse directions in the joggling machine) than other mechanisms such as a hexapod. It may further be capable of forming relatively thick plates into useful shapes without the need for part specific tooling. Such parts may also have advantageous surface properties and residual stresses. It may also be used as a 6 DOF end effector mounted to large 3 DOF machines to enable applications beyond the reach of even the largest general purpose robots. Examples may include, but are not limited to, high load processes such as friction stir welding, and additive friction stir deposition (AFSD). Use of the mechanism taught here in AFSD, with one vise holding the deposited part (similar to how it is used to clamp an extrusion) and the other holding the deposition head, so that most of the forces between the two are reacted by this mechanism, may enable low stiffness machines and robots to move this end effector through space as it builds a part of complex geometry that would be impossible to make, or at the very least highly inefficient to make using the 3D process that is currently used. Efficient creation of complex shapes with changing build direction, without being restricted to a single build direction, may allow for additional contemplated uses.

A series of these 6 DOF actuators, where the fixed platform of one is connected to the moving platform of another, could have interesting applications, for instance, in large scale flexible robots, being used to form the head or tail structures of animatronic figures with powerful, realistic motion, etc.

In the foregoing, the words workpiece and part are used interchangeably to describe the material being manipulated by the apparatus of the present invention. The subtle distinction between the two is that the workpiece may be a piece of raw stock by manipulating which the part of interest is obtained. Since all of the operations described above can be equally implemented on a workpiece as well as a part, this distinction is not material in most cases.

According to an exemplary embodiment, a metal piece, for example an extrusion or an O-sheet, may be fed into the joggling machine as described above. It may be understood that after joggling the piece may maintain its previous curvature.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An apparatus for joggling a workpiece to a specified joggle depth over a specified joggle transition length comprising:
a fixed vise configured to grip a first region of the workpiece between jaws;
a moving vise configured to grip a second region of the workpiece between jaws;
three or more actuators configured to move the moving vise in at least three degrees of freedom with respect to the fixed vise;
wherein the specified joggle transition length is set using displacement control of the distance between the moving vise and the fixed vise; and
wherein the moving vise is actuated to move such that a joggle of the specified joggle depth is created over the specified joggle transition length.

2. The automated joggling machine of claim 1, wherein each of the fixed vise and moving vise are comprised of at least a first jaw, and a second jaw, at least one of which is actuated to clamp the workpiece, wherein when clamped together the first jaw and the second jaw define end planes of jaw clamping at the fixed vise and the moving vise; and
wherein the joggle transition length is set using displacement control of the distance between the end planes of jaw clamping of the fixed and moving vises to the specified value.

3. The apparatus of claim 1, wherein the workpiece is a curved workpiece.

4. The apparatus of claim 1, further comprising one or more sensors that measure the relative position of the fixed vise and the moving vise.

5. The apparatus of claim 4, wherein the one or more sensors are non-contact displacement sensors that measure distances using sensing beams.

6. The apparatus of claim 4, wherein the fixed vise and the moving vise are configured to automatically clamp and unclamp to load and unload the workpiece.

7. The apparatus of claim 6, comprising one or more springback sensors configured to measure the relative position of the workpiece and the vise the sensor is affixed to;
wherein the one or more springback sensors are configured to measure springback generated after a joggling move by unclamping of the vise the sensor is affixed to, while the other vise is still clamped to the workpiece.

8. The apparatus of claim 7, wherein the vise is further configured to compensate for the measured springback by re-clamping the workpiece and changing an actuation distance based on the measured springback.

9. The apparatus of claim 1, wherein the jaws of the fixed vise and the jaws of the moving vise include high friction contact patches on a clamping face.

10. The apparatus of claim 1, further comprising one or more flatness maintainers configured to prevent buckling of a shear leg of the workpiece when undergoing compression.

11. The apparatus of claim 1, further comprising:
one or more independent heater elements;
one or more feedback controllers configured to control the independent heater elements;
one or more temperature sensors configured to measure the temperature of the workpiece;
wherein the one or more independent heater elements are configured to heat and control the temperature of the workpiece for hot joggling.

12. A 6 degrees of freedom controlled system for joggling a workpiece comprising:
a fixed vise configured to grip the workpiece between jaws;
a moving vise configured to grip the workpiece between jaws;
one or more high force hydraulic actuators configured to move the moving vise, each high force hydraulic actuator further comprising two opposed single acting cylinders; and
one or more flow control valves;
wherein the moving vise is configured to move in a controlled motion for non-zero pitch and yaw values by the one or more high force hydraulic actuators.

13. The system of claim 12, further comprising:
one or more sensors; and
one or more measurement points directly located on each of the fixed vise and the moving vise;
wherein the sensors use the one or more measurement points on each of the fixed vise and the moving vise to measure relative position of the fixed vise and the moving vise.

14. The system of claim 13, wherein the workpiece is curved.

15. The system of claim 13, wherein the degrees of freedom include a longitudinal degree of freedom, a first transverse degree of freedom, a second transverse degree of freedom, a first rotational degree of freedom, a second rotational degree of freedom, and a third rotational degree of freedom.

16. The system of claim 15, wherein one or more of the two transverse and three rotational degrees of freedom are simultaneously actuated in coordination to cause specified displacements of the moving vise to bend a first part of the workpiece held in the moving vise a specified amount with respect to a second part of the workpiece held in the fixed vise.

17. The system of claim 16, wherein additional vise sensors affixed to one of the fixed vise and/or moving vise and;
the additional vise sensors are configured to measure the position of the workpiece with respect to the fixed vise and/or moving vise are used to measure the springback of the part upon removing bending forces by unclamping the fixed vise and/or moving vise.

18. The system of claim 17, wherein the longitudinal degree of freedom is actuated to stretch the workpiece by increasing the distance between the fixed vise and the moving vise while the other degrees of freedom are actuated in coordination to bend the workpiece.

19. The system of claim 17, wherein the moving vise is further configured to compensate for the measured springback by re-clamping the workpiece and changing the specified displacements based on the measured springback.

20. The system of claim 17, further comprising a feeder configured to feed the workpiece through both the fixed vise and the moving vise by a predetermined incremental move distance when the grips are not gripping the workpiece.

21. A method for joggling a workpiece comprising:
gripping the workpiece at a first region by a fixed vise and gripping the workpiece at a second region by a moving vise;
setting a specified joggle transition length using displacement control of the distance between the moving vise and the fixed vise;
actuating the moving vise such that a joggle of a predetermined joggle depth is created over the specified joggle transition length of the workpiece;
wherein the actuation is performed by three or more actuators configured to move the moving vise in at least three degrees of freedom with respect to the fixed vise.

22. An apparatus for moving a gripped first region of a first object with respect to a gripped second region of a second object, comprising:
a fixed vise configured to grip the first region of the first object;
a moving vise configured to grip the second region of the second object; and
six or more actuators configured to move the moving vise in at least six degrees of freedom with respect to the fixed vise;
wherein at least one of the actuators is a double acting actuator configured to move the moving vise with respect to the fixed vise in both the positive and negative directions of one degree of freedom by having a first end and a second end that push against a first opposed surface and a second opposed surface, respectively;
the first opposed surface and the second opposed surface are rigidly disposed with respect to one another;
the double-acting actuator is comprised of a pair of opposed single acting actuators that are configured to move independently to change the effective length between the first end and the second end to accommodate changes in distance between the first opposed surface and the second opposed surface due to relative rotation of the moving vise with respect to the fixed vise; and
the first end and the second end have swivel feet that are configured to apply compressive forces against the first opposed surface and the second opposed surface while sliding with respect to them.

23. The apparatus of claim 22, wherein the first object and the second object are a first region of a same object and a second region of a same object.

24. The apparatus of claim 22, wherein the single acting actuators are single acting hydraulic cylinders that are connected to a first port and a second port of a flow control valve or servo-valve.

25. The apparatus of claim 22, wherein the swivel feet have low friction surfaces that minimize sliding forces and wear on the opposed surfaces.
